(19) United States
(12) Patent Application Publication
(10) Pub. No.: US 2026/0179073 A1
(43) Pub. Date: Jun. 25, 2026

(54) DETECTION OF BAGGED ITEMS AT A CHECKOUT STATION

(71) Applicant: Zebra Technologies Corporation, Lincolnshire, IL (US)

(72) Inventors: Darran Michael Handshaw, Sound Beach, NY (US); Andrea Mirabile, London (GB); Francesco Lupo, London (GB)

(21) Appl. No.: 18/989,981

(22) Filed: Dec. 20, 2024

(51) Int. Cl. G06Q 20/20; G06V 20/60

(52) U.S. Cl. CPC G06Q 20/208; G06V 20/60

(57) ABSTRACT

The present disclosure relates to an apparatus and method for processing items at a checkout station. The apparatus includes a housing with a scale assembly supporting a weigh platter, a vision assembly with a field of view over the platter, a processor, and memory storing executable instructions. These instructions enable capturing image frames before and during a time when the scale reports a stable, non-zero weight, analyzing these images to identify items, and transmitting item data to a host. If identification fails, earlier images are analyzed. The system may include an indicia imaging assembly, a decoder, and an item identification module, potentially residing on separate circuits. A wakeup system and object tracking system enhance operation. A corresponding method and computer-readable medium execute similar functions to improve item recognition, even with obstructions such as bags, providing reliable data for checkout processes.

### BACKGROUND

Produce recognition is becoming an increasingly important technology in the retail sector and particularly in the grocery store space. Items like apples, lemons, avocados, and many others are often provided without packaging, allowing the customer to select as many items as they wish. Due to the lack of packaging at the source many of these items often lack a corresponding indicium being attached to them creating obstacles to recognizing what the item is in a relatively automated manner. Recent advancements in vision technologies have made it possible to recognize certain item based on vision analysis. However, these approaches work best when items are presented to the vision system without any obstructions. Unfortunately, a majority of produce is bagged before boing brought to a checkout counter and these bags often create a visual barrier for the vision system. Additionally, portions of the bag like the bag top may altogether obscure the items, preventing accurate detection. Accordingly, there is a need for improved devices, methods, and systems for recognizing bagged produce at checkout stations.

### SUMMARY

In an embodiment, the present invention provides an apparatus for processing items at a checkout station. This apparatus comprises a housing, a scale assembly positioned at least partially within the housing and supporting a weigh platter, a vision assembly having a field of view extending at least partially over the weigh platter, a processor communicatively coupled with the scale assembly and the vision assembly, and a memory communicatively coupled with the processor. The memory stores instructions that, when executed by the processor, cause the apparatus to perform several operations: capturing, via the vision assembly, at least one image frame before a time T, where time T is a time when the scale assembly reports a stable, non-zero weight; capturing, via the vision assembly, an image frame during the time T; analyzing, via the processor, the image frame captured during time T to attempt to identify an item within the field of view of the vision assembly; and responsive to successfully identifying the item from the image frame captured during time T, transmitting item-associated data to a host. If the item cannot be identified from the image frame captured during time T, the apparatus analyzes the at least one image frame captured before time T to identify the item and transmits item-associated data to the host.

Additionally, the apparatus may further comprise an indicia imaging assembly and a decoder module, wherein image data captured by the indicia imaging assembly is processed by the decoder module, and image data captured by the vision assembly is processed by an item identification module. The decoder module and the item identification module may reside on separate physical circuits. The housing may include a lower portion and a tower portion, with the field of view of the vision assembly extending through a window of the tower portion, and the scale assembly positioned within the lower portion of the housing. The apparatus may also include a wakeup system operable to transition the apparatus from a sleep state to an awake state, where capturing the at least one image frame before time T commences in response to the apparatus entering the awake state. An object tracking system may be included, operable to track objects through the field of view of the vision assembly, with capturing commencing in response to detecting an object entering the field of view. If identification from the image frame captured before time T is unsuccessful, the apparatus provides a prompt to reposition the item on the weigh platter.

Example embodiments also encompass a method for processing items at a checkout station, which includes capturing, via a vision assembly, at least one image frame before a time T, capturing an image frame during time T, analyzing this image to identify an item, and transmitting item-associated data to a host upon successful identification. If identification is unsuccessful, the method includes analyzing the image frame captured before time T to identify the item and transmitting the data accordingly. This method may also involve processing image data captured by an indicia imaging assembly with a decoder module and processing image data captured by the vision assembly with an item identification module, with these modules potentially residing on separate circuits. The method further includes transitioning from a sleep state to an awake state using a wakeup system and tracking objects through the field of view with an object tracking system. Additionally, a prompt to reposition the item may be provided if identification is not successful.

Finally, the additional embodiments include a non-transitory computer-readable medium storing instructions that, when executed by a processor, cause an apparatus to perform the operations detailed in the method, thereby enabling effective processing of items at a checkout station.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example workstation for implementing concepts described in the present disclosure.

FIG. 2 illustrates an example block diagram of the system of FIG. 1.

FIG. 3 illustrates an example flowchart representative of a process for implementing the concepts described in the present disclosure.

FIGS. 4A-4C illustrate example images captured by a vision system of an example barcode reader in accordance with the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As noted above, to effectively identify objects presented for checkout, the vision system needs to avoid substantial visual barriers. The present disclosure presents novel approaches to identifying objects even when the vision system may be blocked at certain times.

Generally speaking, customers or cashiers at retail venues like grocery stores typically use indicia readers (like bi-optic barcode readers) to process items for purchase. Often when purchasing items like produce (e.g., apples) those items are bagged in a plastic bag and this bag is then placed on the weigh platter of the indicia reader to continue with the checkout process. At this time a vision system may be utilized to help determine what the object is that is within the bag. However, there are times when the translucent nature of the bag prevents the vision system from capturing images of sufficient quality to then render an item determination with a sufficient level of confidence. This problem can be exacerbated by instances where a top of the bag falls within the field of view of the vision system, creating a visual barrier for the vision system. Accordingly, the concepts described herein utilize images captured earlier in time than those which may normally be relied on to increase the accuracy of item detection.

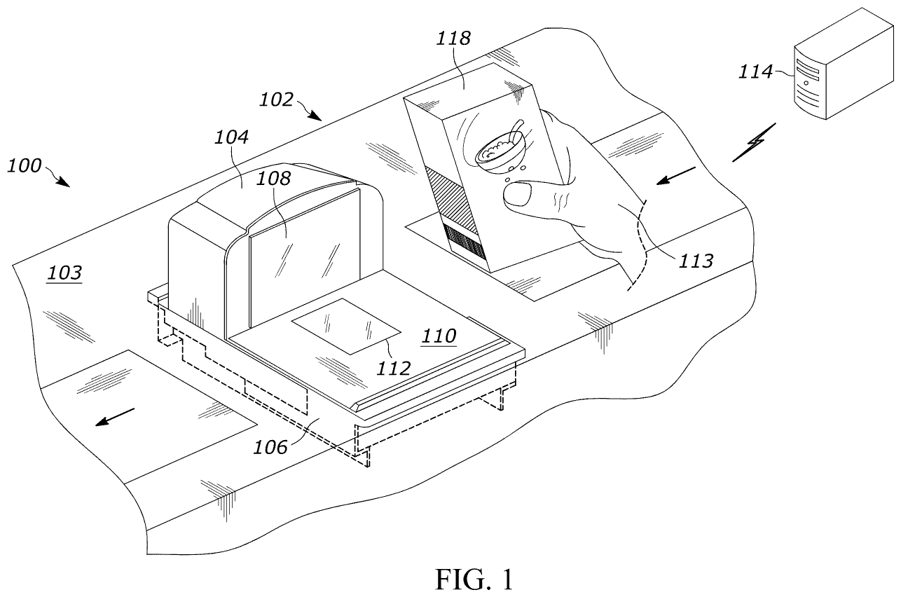

Referring to FIG. 1, it illustrates a perspective view of an example bioptic indicia reader 100 for identifying items in accordance with various embodiments of the present disclosure. As used herein, the term indicia should be understood to refer to any kind of visual marker that can be associated with an item. For example, indicia can be a 1D, 2D, or 3D barcode, a graphic, a logo, etc. Additionally, indicia may comprise encoded payload data as, for example, is the case with a 1D or 2D barcode where the barcode encodes a payload comprised of, for example, alphanumeric or special characters that may be formed into a string. In the illustrated example, the bioptic indicia reader 100 is shown as part of a point-of-sale (POS) system arrangement 102 having the bioptic indicia reader 100 positioned within a workstation counter 103. Generally, the indicia reader 100 includes an upper housing 104 (also referred to as an upper portion, upper housing portion, or tower portion) and a lower housing 106 (also referred to as a lower portion, lower housing portion, or platter portion). The upper housing 104 can be characterized by an optically transmissive window 108 positioned therein along a generally vertical plane and a horizontally extending field of view(s) which passes through the window 108. The lower housing 106 can be characterized by a platter 110 that includes an optically transmissive window 112 positioned therein along a generally horizontal plane and a vertically extending field of view(s) which passes through the window 112. The platter 110 may be a weigh platter and can be a part of a weigh platter assembly that generally includes the weigh platter 110 and a scale (or load cell) configured to measure the weight of an object placed the top surface of the weight platter 110. To avoid weight disturbances, the weigh platter is generally configured to rest wholly on the load cell (or portions thereof designed to support the weigh platter) such that the entire weight of the weigh platter along with any object placed therein is fully transferred to the load cell.

In operation, the indicia reader 100 can be used in multiple modes, including a mode where item-related data is passed to a point-of-sale (POS) host device based on the weight of an item involved in a transaction and a mode where item-related data is passed to a POS host device without regard for the weight of an item involved in a transaction.

In the latter mode, a user 113 generally passes an item 114 across a product scanning region of the indicia reader 100 in a swiping motion in some general direction, which in the illustrated example is right-to-left. A product scanning region can be generally viewed as a region that extends above the platter 110 and/or in front of the window 108 where indicia reader 100 is operable to capture image data of sufficient quality to perform imaging-based operations like decoding indicia that appears in the obtained image data. It should be appreciated that while items may be swiped past the indicia reader 100 in either direction, items may also be presented into the product scanning region by means other than swiping past the window(s). When the item 114 comes into one of more of the fields of view of the reader, the indicia 116 on the item 114 is captured and decoded by the indicia reader 100, and corresponding data is transmitted to a communicatively coupled host 118 (commonly comprised of a point of sale (POS) terminal). Further to capturing data for decode purposes, the indicia reader may have one or more imaging assemblies configured for capturing streams of image data used for vision purposes. These can include, but are not limited to object identification, user observation, shrink detection, and other vision operations which do not directly rely on the decoding of an indicia.

Indicia reader 100 can utilize a variety of imaging assemblies and optical components to achieve the desired field of view(s) FOV(s) over which image data can be captured and transmitted to a processing host (such as a decoder, processor (like a video processor), or ASIC that may be internal to the indicia reader 100). For example, an imaging assembly may include an image sensor (also referred to as an imager or imaging sensor) that can be, for example, a CCD or a CMOS imaging sensor and may either be a linear or a two-dimensional sensor. Linear image sensors generally include multiple photosensitive pixel elements aligned in a one-dimensional array. Two-dimensional sensors generally include mutually orthogonal rows and columns of photosensitive pixel elements arranged to form a substantially flat square or rectangular surface. Such imagers are operative to detect light captured by an imaging lens assembly along a respective optical path or axis that normally traverses through either of the generally horizontal or generally upright window(s). In instances where multiple imaging assemblies are used, each respective imager and imaging lens assembly pair is designed to operate together for capturing light scattered, reflected, or emitted from indicia as pixel data over a respective FOV. In other instances, a single imaging assembly may be used to generate a single primary FOV which may be split, divided, and/or folded to generate multiple FOVs. In such cases, data collected from various portions of the imaging sensor may be evaluated as if it was obtained by an individual imaging assembly/imaging sensor.

Additionally, different imaging assemblies may be communicatively coupled to different processing components for appropriate data processing.

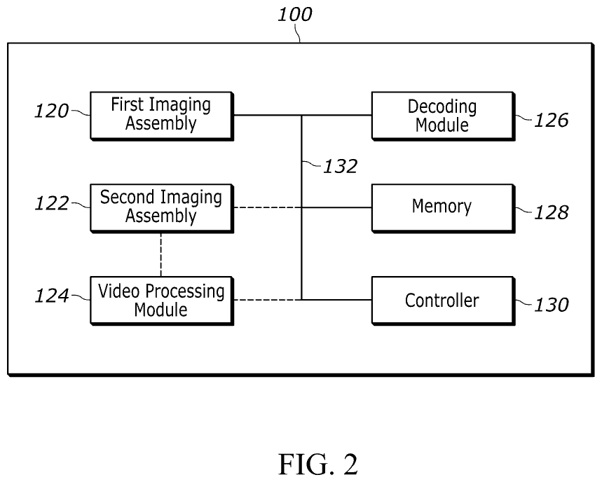

Referring now to FIG. 2, shown therein is a block diagram representing an example indicia reader 100 of the present disclosure. Reader 100 generally includes a first imaging assembly 120 and a second imaging assembly 122. In some embodiments, the first imaging assembly 120 is optimized for capturing image data for indicia decoding purposes and the second imaging assembly 122 is optimized for capturing image data for vision processing purposes that go beyond indicia decoding. Additionally, the reader 100 includes a video processing module 124 configured to receive image data from the imaging assembly that is optimized for capturing image data for vision processing purposes (e.g., second imaging assembly 122) and conduct machine vision processing operations thereon. The video processing module 124 is embodied in a hardware device that can include its own processing and control circuitry along with memory and relevant instructions for performing the necessary operations. The reader 100 also includes a decoding module 126 (also referred to as a decoder or a decoder module) configured to accept image data from the imaging assembly optimized for capturing barcode data (e.g., first imaging assembly 120) and process said data to extract one or more payloads associated with various indicia present in said image data. The decoding module may be embodied in a hardware configuration, or it may be a logical module that is a part of some relatively general-purpose processor. Additionally, the reader 100 includes a memory 128 and a controller 130 whereby the memory stores machine readable instructions which, when executed by the controller (also referred to as a processor) cause the reader 100 to operate as intended. The various modules and assemblies of reader 100 are communicatively coupled via the bus 132 which is illustrated logically and not literally. It should be appreciated the second imaging assembly and the video processing module can be coupled in any number of ways where information from the second imaging assembly may be received by the video processing module. For example, the video processing module 124 may be connected to the second imaging assembly 124 and the bus 132, whereby control signal information may be transmitted to the second imaging assembly 122 via the video processing module 124. In other instances, the link to the bus 132 may be established via the second imaging assembly 122. Additionally, image data may be passed from the image assembly to the video processing module via the 132, but omitting the connection between the imaging assembly and the video processing module.

Normally, indicia decoding does not require image data of relatively high fidelity. Instead, this data can be of relatively low quality, being presented in monochrome and captured over fields of view that are specifically configured for likely presence of said indicia during checkout procedures. These images are typically not suitable non-decoding, vision processing (like item recognition) due to their relatively low quality and limited field of view orientation. On the other hand, vision processing (like item recognition) typically requires images of relatively high fidelity, providing color and texture data, and being of sufficient resolution so as to resolve appropriate item details. As a result, images transmitted to the decoder are obtained by a one imaging assembly that is optimized to capture images sufficient quality for barcode decoding and images transmitted to a vision processor are captured by a different imaging assembly optimized to capture images of sufficient quality for the desired non-decoding vision purposes.

However, while the image data for decoding purposes commonly comes in over multiple fields of view oriented in different directions (commonly achieved through filing and splitter mirrors), image data for non-decode vision purposes is typically received from less directions, making it difficult to perform appropriate vision analysis if an item is obscured from view by something like a plastic bag. The problem can be further compounded by the fact that barcode decoding can normally occur at any time that a barcode is visible within a field of view. On the other hand, vision operations like item recognition are generally performed on items, like produce, when those items are placed on the weigh platter. Consequently, the pool of image data from which the reader can effectively conduct its analysis is reduced, making the problem of item identification in cases of obstructions even more prevalent.

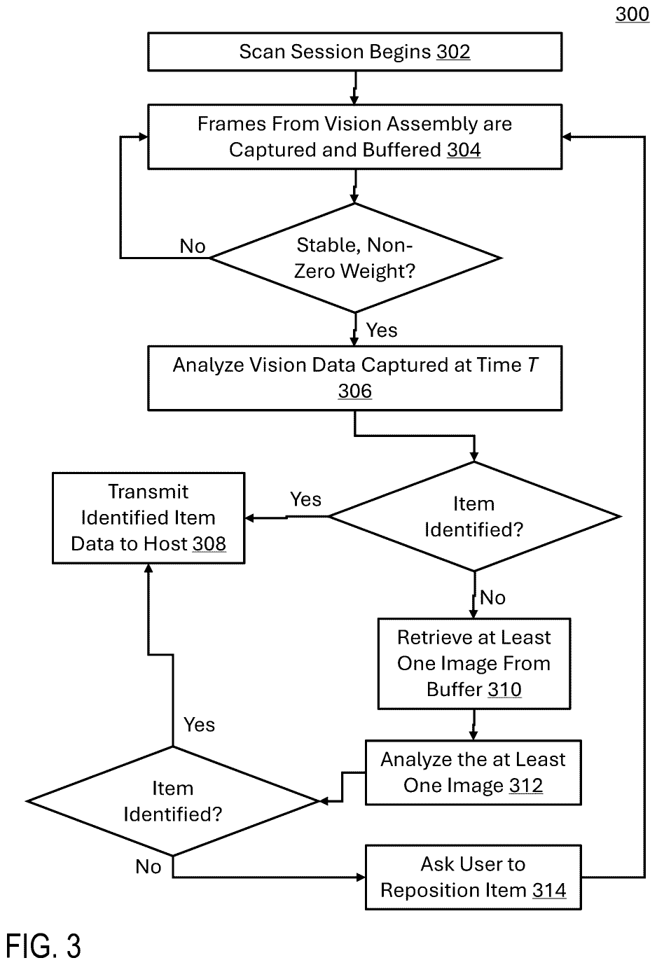

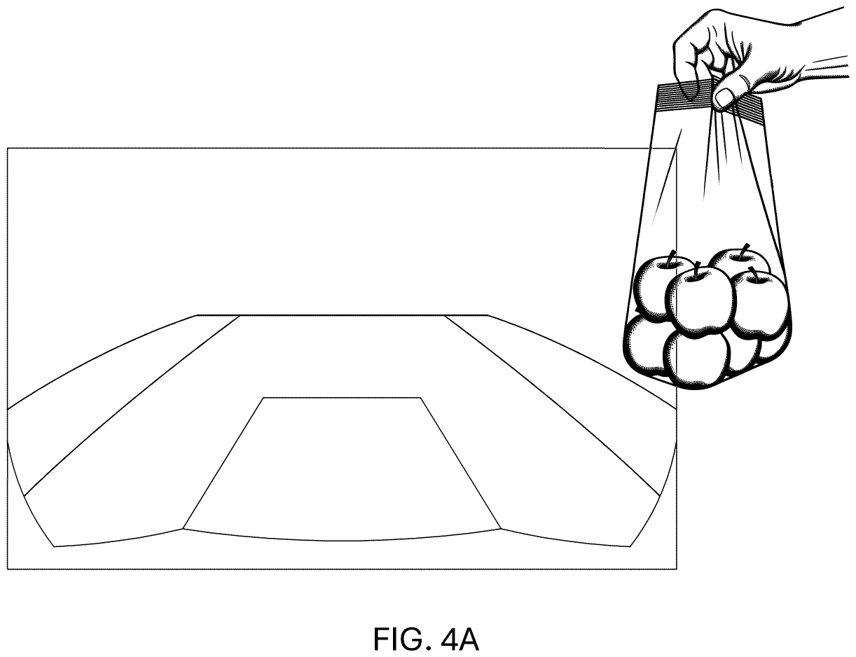

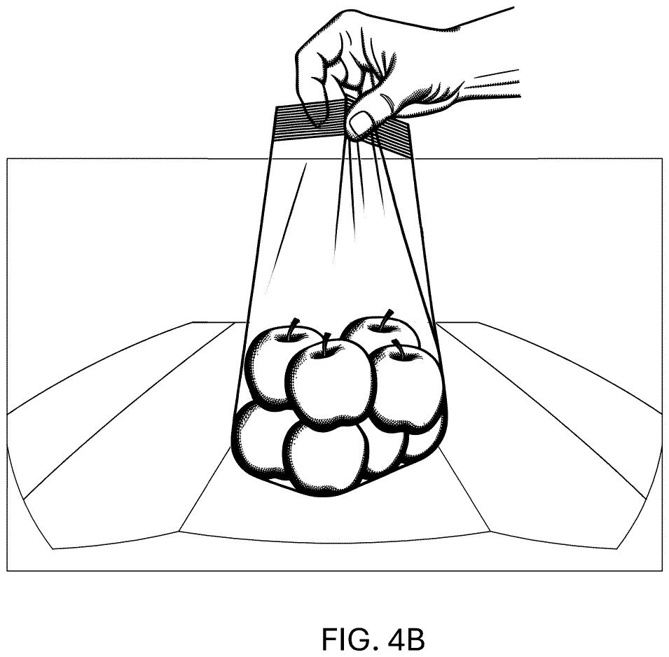

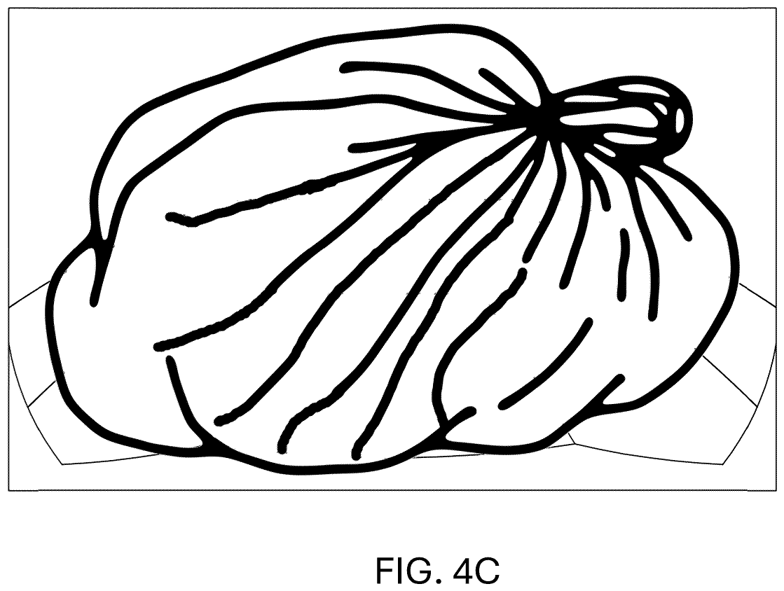

FIG. 3, which illustrates a flowchart 300 representative of a method of operating an indicia reader in accordance with embodiments of the present disclosure, along with FIGS. 4A-4C, which illustrates representations of image data captured by a vision imaging assembly of an indicia reader, provide a solution to the foregoing problem by extracting earlier-captured vision data if and when this is necessary.

In various embodiments, the process can be described as beginning with step 302 where the scan session begins. This can be triggered by a wake-up signal being received from an IR sensor/detector combination, image analysis of images captured by any of the imaging assemblies associated with the reader, or any other means suitable to transition the reader 100 from a state where no decoding/item recognition is occurring to a state where decoding and/or item recognition is happening. When the scan session begins, images from the vision imaging assembly are captured and at least some of them are buffered in memory in step 304. When a user attempts to process an item like produce, that item will be placed on the weigh platter. Representative images captured during step 302 are illustrated in FIGS. 4A and 4B where a user is in the process of bringing a bag of apples to be placed on the weigh platter, with FIG. 4A showing an image captured just as the item is brought into the field of view and FIG. 4B showing an image captured as the item is being moved into place on the platter.

Once the item is placed on a scale and no disturbances are detected, the scale generates a stable, non-zero weight. In response to this stable (the scale no longer detects variations in weight for a duration of time), non-zero weight the image data (captured by the vision imaging assembly) of the item on the weigh platter is transmitted to and analyzed by 306 the vision module. It may be said that this image data is captured at time T where T is the time when the item is positioned on the weigh platter with a stable non-zero weight. An example image captured at time T is illustrated in FIG. 4C.

If the item can be effectively identified from the vision data captured at time T, the item data is transmitted 308 to the appropriate host (internal and/or external) for further processing as needed by the system. This can include price lookup, item verification for ticket switching purposes, model training, etc. However, in some cases the bag may be positioned such that its creases, top, overall positioning creates a visual barrier making it impossible to effectively capture an image of the item(s) inside. This is represented by the FIG. of 4C where the apples that were inside the bag are no longer visible. In this case, if the item cannot be recognized, the reader is configured to retrieve 310 at least one image (like images shown in FIGS. 4A and 4B) stored in the memory in step 304 and analyze that at least one image in an attempt to determine the item that was placed on the weigh platter. The image(s) selected for analysis may be any one or more images taken from the memory buffer. Preferably these images are selected from the moment that the object enters the field of view of the reader and up to the moment of time T.

In certain embodiments, the images selected for the analysis step 312 may be evaluated in reverse chronological order. This may be useful particularly in cases where a top of the bag falls over and blocks a field of view once the items are placed on the platter. Reviewing images in reverse chronological order can allow the system to backtrack until an image of sufficient quality is evaluated such that the product is identified. In certain embodiments the images selected for evaluation may be selected at any predetermined time between the moment that the item enters the field of view and time T. This approach may allow the item to be better seen from a more distant vantage point as more of an item may be visible at that time.

If, in step 312, the item can be identified or a relevant item parameter can be extracted, this information can be transmitted to the host as is done in step 308. On the other hand, if item recognition is still unsuccessful in step 312, the user may be prompted, in step 314, to reposition the item on the platter. This can be done through a visual display, an audible signal, a visual indicator like blinking lights, or other means suitable for conveying the request to the user. As the item is repositioned, the process returns to step 304 to once again conduct the necessary analysis.

It should be appreciated that issues of non-recognition may not necessarily arise just to obscurations by a produce bag. The issue may also happen when only a portion of an item is left visible to the field of view once the item is placed on the platter. Thus, concepts described herein can also extend to instances where the item cannot be detected in step 306 regardless of the reason for the inability to conduct accurate detection.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines.

Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present).

Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An apparatus for processing items at a checkout station, comprising:
a housing;
a scale assembly positioned at least partially within the housing and supporting a weigh platter;
a vision assembly having a field of view extending at least partially over the weigh platter;
a processor communicatively coupled with the scale assembly and the vision assembly; and
a memory communicatively coupled with the processor and storing instructions that, when executed by the processor, cause the apparatus to:
capture, via the vision assembly, at least one image frame before a time T, wherein the time T is a time when the scale assembly is reporting a stable, non-zero weight;
capture, via the vision assembly, an image frame during the time T;
analyze, via the processor, the image frame captured during time T to attempt to identify an item within the field of view of the vision assembly;
responsive to successfully identifying the item from the image frame captured during time T, transmit item-associated data to a host; and
responsive to not being able to identify the item from the image frame captured during time T, analyze, via the processor, the at least one image frame captured before the time T to identify the item and transmit item-associated data to the host.

2. The apparatus of claim 1, further comprising an indicia imaging assembly and a decoder module, wherein image data captured by the indicia imaging assembly is processed by the decoder module, and wherein image data captured by the vision assembly is processed by an item identification module.

3. The apparatus of claim 2, wherein the decoder module and the item identification module reside on separate physical circuits.

4. The apparatus of claim 1, wherein the housing includes a lower portion and a tower portion, and wherein the field of view of the vision assembly extends through a window of the tower portion.

5. The apparatus of claim 4, wherein the scale assembly is positioned within the lower portion of the housing.

6. The apparatus of claim 1, further comprising a wakeup system operable to transition the apparatus from a sleep state to an awake state, and wherein capturing the at least one image frame before the time T, commences in response to the apparatus entering the awake state.

7. The apparatus of claim 1, further comprising an object tracking system operable to track objects through the field of view of the vision assembly, and wherein capturing the at least one image frame before the time T, commences in response to the object tracking system detecting an object entering the field of view of the vision assembly.

8. The apparatus of claim 1, wherein responsive to not being able to identify the at least one image frame captured before the time T, the apparatus provides a prompt to reposition the item on the weigh platter.

9. A method for processing items at a checkout station, comprising:
capturing, via a vision assembly, at least one image frame before a time T, wherein the time T is a time when a scale assembly reports a stable, non-zero weight;
capturing, via the vision assembly, an image frame during the time T;
analyzing, via a processor, the image frame captured during time T to attempt to identify an item within the field of view of the vision assembly;
responsive to successfully identifying the item from the image frame captured during time T, transmitting item-associated data to a host; and
responsive to not being able to identify the item from the image frame captured during time T, analyzing, via the processor, the at least one image frame captured before the time T to identify the item and transmitting item-associated data to the host.

10. The method of claim 9, further comprising:
processing image data captured by an indicia imaging assembly with a decoder module, while processing image data captured by the vision assembly with an item identification module.

11. The method of claim 10, wherein the decoder module and the item identification module reside on separate physical circuits.

12. The method of claim 9, wherein the vision assembly's field of view extends through a window of a tower portion of a housing.

13. The method of claim 12, wherein the scale assembly is positioned within a lower portion of the housing.

14. The method of claim 9, further comprising transitioning from a sleep state to an awake state using a wakeup system, and wherein capturing the at least one image frame before the time T commences in response to entering the awake state.

15. The method of claim 9, further comprising:
tracking objects through the field of view of the vision assembly with an object tracking system, and wherein capturing the at least one image frame before the time T commences in response to detecting an object entering the field of view of the vision assembly.

16. The method of claim 9, further comprising:
providing a prompt to reposition the item on the weigh platter if the item cannot be identified from the at least one image frame captured before the time T.

17. A non-transitory computer-readable medium storing instructions that, when executed by a processor, cause an apparatus to:
capture, via a vision assembly, at least one image frame before a time T, wherein the time T is a time when a scale assembly reports a stable, non-zero weight;
capture, via the vision assembly, an image frame during the time T;
analyze the image frame captured during time T to attempt to identify an item within the field of view of the vision assembly;
responsive to successfully identifying the item from the image frame captured during time T, transmit item-associated data to a host; and
responsive to not being able to identify the item from the image frame captured during time T, analyze the at least one image frame captured before the time T to identify the item and transmit item-associated data to the host.

18. The computer-readable medium of claim 17, further comprising instructions that, when executed, cause the apparatus to:
process image data captured by an indicia imaging assembly with a decoder module, while processing image data captured by the vision assembly with an item identification module.

19. The computer-readable medium of claim 18, wherein the decoder module and the item identification module reside on separate physical circuits.

20. The computer-readable medium of claim 17, further comprising instructions that, when executed, cause the apparatus to:
provide a prompt to reposition the item on the weigh platter if the item cannot be identified from the at least one image frame captured before the time T.
